(19) United States
(12) Patent Application Publication
(10) Pub. No.: US 2019/0068704 A1
(43) Pub. Date: Feb. 28, 2019

(54) DETERMINING A TIME FOR EXECUTING A COMMAND ON A DEVICE

(71) Applicant: Futureworks International Limited, Hong Kong (HK)

(72) Inventors: Jay Adlao Block, Makati (PH); Martin Andreas Block, Makati (PH)

(21) Appl. No.: 16/115,544

(22) Filed: Aug. 28, 2018

Related U.S. Application Data
(60) Provisional application No. 62/551,775, filed on Aug. 29, 2017.

(51) Int. Cl. H04L 29/08

(52) U.S. Cl. CPC H04L 67/1095

(57) ABSTRACT

A method of determining a time for executing a command on a device of a plurality of devices is disclosed. In an embodiment, the method includes requesting a host computing system for network time and retrieving via the host computing system the network time. The method further includes determining a device time of each of the plurality of devices. The method further includes determining a true offset between the network time and the device time of each of the plurality of devices, such that the true offset is determined iteratively based on a predetermined offset threshold range (POTR). The method further includes determining the time for executing the command based on the true offset between the network time and the device time of each of the plurality of devices.

### CROSS REFERENCE TO RELATED APPLICATIONS

The present application claims the benefit of U.S. provisional application No. 62/551,775 filed on Aug. 29, 2017. All the above are hereby incorporated by reference.

### TECHNICAL FIELD

This disclosure relates generally to synchronization of device time associated with a device of a plurality of devices with network time, and more particularly to determining a time for executing a command on each of a plurality of devices.

### BACKGROUND

Some application may require multiple devices, such as smartphones operating on the Android platform, to execute commands synchronously or as close to each other as possible. For example, some applications may require zero to very little discrepancies with respect to time for proper execution of commands In such cases, time synchronization between the device times associated with the multiple devices may be crucial.

Typically, a device may rely on Network Time Protocol (NTP) to synchronize its device time to a network time server, also referred to as NTP server, online. However, it is observed that the device time associated with the device may not be exactly synchronized, and network travel times and layers of servers may cause a time offset between the device time associated with the device and the network time, in some cases of +/−1 seconds. Further, the physical nature of the device may affect the tick duration leading to the time offset. Hence, time synchronization between the multiple devices may assume greater importance for subsystems or modules to work seamlessly with each other.

By way of an example, the synchronization between each of the multiple devices may be achieved by synchronizing each of the multiple devices with a host computer device. It may be important to overcome the offset between device time associated with of each of the plurality of devices and the network time (as retrieved via the host computer device) for synchronizing the device with the network time seamlessly execute a command on the device.

A possible solution of compensating the offset is to change the device time associated with the device. However, it may not be possible for developers to programmatically change the device time for devices operating on Android platform (unless it is rooted which is usually not preferred by manufacturers or is not allowed in some countries). The presently known techniques do not provide any solution for computing the time offset between the device time of the device and the network time without the need of changing the device time of the device. Further, the known techniques do not provide an accurate way of overcoming the offset between device time associated with each of the plurality of devices and the network time.

### SUMMARY

In one embodiment, a method for determining a time for executing a command on a device of a plurality of devices is disclosed. In an embodiment, the method may include requesting a host computing system for network time. The method may further include retrieving via the host computing system the network time. The method may further include determining a device time of each of the plurality of devices. The method may further include determining a true offset between the network time and the device time of each of the plurality of devices, such that the true offset between the network time and the device time of each of the plurality of devices is determined iteratively based on a predetermined offset threshold range (POTR). The method may further include determining the time for executing the command based on the true offset between the network time and the device time of each of the plurality of devices.

In another embodiment, a device for determining a time for executing a command on each of a plurality of devices is disclosed. The device includes a processor and a memory communicatively coupled to the processor, wherein the memory stores processor instructions, which, on execution, causes the processor to request a host computing system for network time. The processor instructions further cause the processor to retrieve via the host computing system the network time. The processor instructions further cause the processor to determine a device time of each of the plurality of devices. The processor instructions further cause the processor to determine a true offset between the network time and the device time of each of the plurality of devices, such that the true offset between the network time and the device time of each of the plurality of devices is determined iteratively based on a predetermined offset threshold range (POTR). The processor instructions further cause the processor to determine the time for executing the command based on the true offset between the network time and the device time of each of the plurality of devices.

In yet another embodiment, a non-transitory computer-readable storage medium is disclosed. The non-transitory computer-readable storage medium has instructions stored thereon, a set of computer-executable instructions causing a computer comprising one or more processors to perform steps comprising requesting a host computing system for network time; retrieving via the host computing system the network time; determining a device time of each of the plurality of devices; determining a true offset between the network time and the device time of each of the plurality of devices, such that the true offset between the network time and the device time of each of the plurality of devices is determined iteratively based on a predetermined offset threshold range (POTR); and determining the time for executing the command based on the true offset between the network time and the device time of each of the plurality of devices.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram illustrating an environment for determining a time for executing a command on each of a plurality of devices, in accordance with an embodiment;

FIG. 2 is block diagram illustrating an environment for determining a time for executing a command on each of a plurality of devices, in accordance with another embodiment;

FIG. 3 is a block diagram illustrating an environment for determining a time for executing a command on each of a plurality of devices, in accordance with yet another embodiment;

FIG. 4 illustrates a functional block diagram of a memory of a device of the plurality of devices for determining a time for executing a command on each of a plurality of devices, in accordance with yet another embodiment;

FIG. 5A illustrates the first run of an exemplary algorithm for determining a true offset between network time and the device time of each of the plurality of devices, in accordance with an embodiment.

FIG. 5B illustrates a second run of an exemplary algorithm for determining a true offset between network time and the device time of each of the plurality of devices, in accordance with an embodiment.

FIG. 5C illustrates the third run of an exemplary algorithm for determining a true offset between network time and the device time of each of the plurality of devices, in accordance with an embodiment.

FIG. 6 illustrates a timing chart of determining a time for executing a command on each of a plurality of devices, in accordance with another embodiment;

FIG. 7 illustrates a flowchart of a method for determining a time for executing a command on each of a plurality of devices, in accordance with another embodiment;

FIG. 8 illustrates a flowchart of a method for determining a true offset between network time and the device time of each of the plurality of devices, in accordance with an embodiment;

FIG. 9 illustrates a flowchart of a method for determining a true offset between network time and the device time of each of the plurality of devices, in accordance with yet another embodiment;

FIG. 10 illustrates a block diagram of an exemplary computer system for implementing embodiments consistent with the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description is considered as exemplary only, with the true scope and spirit being indicated by the following claims. Additional illustrative embodiments are listed below.

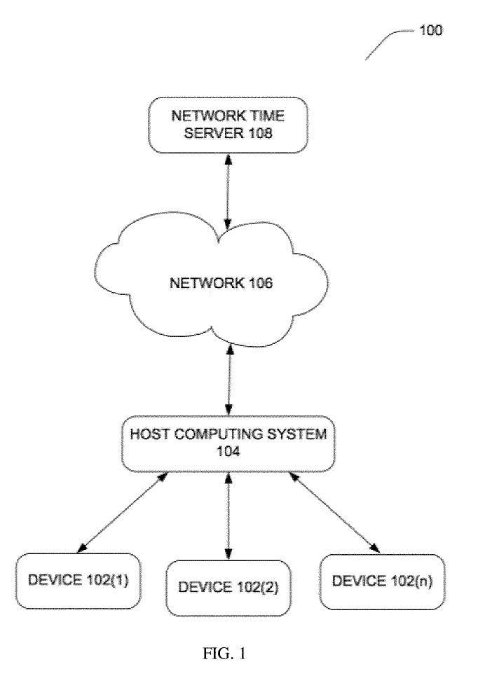

In one embodiment, an environment 100 for determining a time for executing a command on each of a plurality of devices is illustrated in the FIG. 1, in accordance with an embodiment. The environment 100 may include a plurality of devices 102(1), 102(2) . . . 102(n), hereinafter, collectively referred to as devices 102. The environment 100 may further include a host computing system 104 communicatively coupled to a network time server (also referred to as network time protocol (NTP) server, or simply server) 108 through a network 106.

In an embodiment, each device of the devices 102 may be a device operating on the Android platform. For example, each device of the devices 102 may be an Android-based smartphone. Further, each device of the devices 102 may be communicatively coupled to the host computing system 104. In an embodiment, each device of the devices 102 may be communicatively coupled to the host computing system 104 through a Wi-Fi connection. However, in other embodiments, each device of the devices 102 may be communicatively coupled to the host computing system 104 through any other connection type without deviating from the scope of the invention. Further, in an embodiment, each device of the devices 102 may be communicatively coupled to the host computing system 104 via a Wi-Fi router (not shown in FIG. 1). Further, each device of the devices 102 may be communicatively coupled with each other.

The host computing system 104 may be any computing device, such as a desktop, a laptop, a mobile phone, etc. In an embodiment, the host computing system 104 may be a computing device operating on Microsoft Windows® platform. The host computing system 104 may be responsible for triggering a command execution on each of the devices 102. Further, the host computing system 104 may be network time protocol (NTP) enabled. The host computing system 104 may further be communicatively coupled with the network time server 108 via the network 106. The network 106 may be a wired or a wireless network and the examples may include but are not limited to the Internet, Wireless Local Area Network (WLAN), Wi-Fi, Long Term Evolution (LTE), Worldwide Interoperability for Microwave Access (WiMAX), and General Packet Radio Service (GPRS). Therefore, each device of the devices 102 may connect to the network time server 108 via the host computing system 104.

During operation, each device of the devices 102 may request the host computing system 104 for network time. The host computing system 104 may, in turn, communicate with the network time server 108 to retrieve the network time. Thereafter, each device of the devices 102 may retrieve the network time via the host computing system 104. Further, each device of the devices 102 may then determine device time associated with each of the respective devices. As mentioned earlier, there may exist an offset between the network time and the device time associated with each device of the devices 102. Further, each device of the devices 102 may then determine iteratively a true offset between the network time and the device time associated with each device of the devices 102, based on a predetermined offset threshold range (POTR). Based on the true offset between the network time and the device time associated with each device of the devices 102, a time for executing a command on each device of the devices 102 may be determined.

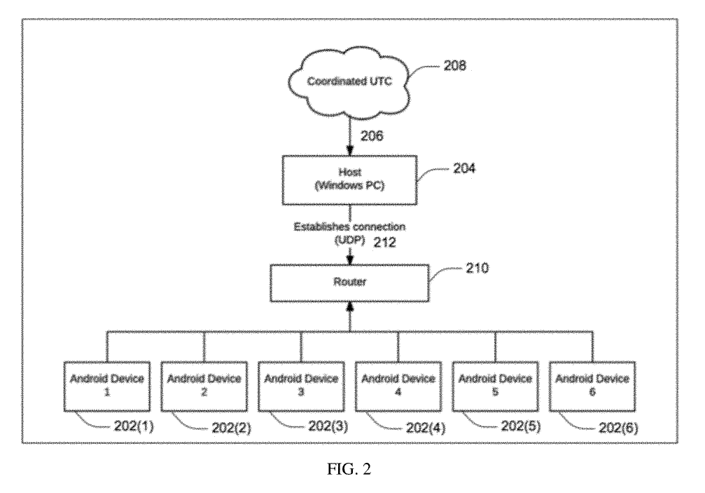

FIG. 2 shows an environment 200 for determining a time for executing a command on a plurality of devices, in accordance with another embodiment. The environment 200 may include a plurality of devices 202(1), 202(2) . . . 202(6), hereinafter, collectively referred to as devices 202 (corresponding to devices 102 of FIG. 1). The environment 200 may further include a router 210, a host computing system 204 and a network time server 208. Each of the devices 202 may be communicatively coupled to the host computing system 204 via the router 210. The router 210 may, thus, provide a platform for allowing each of the devices 202 to connect to the host computing system 204. The host computing system 204 may further be communicatively coupled to the network time server 208 through a network 206. In an embodiment, each device of the devices 202 may be communicatively coupled to the host computing system 204 via a wireless network, such as Wi-Fi.

In an embodiment, the host computer 204 may connect to the router 210 to establish a local area network 212. Once the connection is established, each of the devices 202 may connect to the local area network 212 and hence the host computing system 204 via the router 210. In an embodiment, the connection between each device of the devices 202 and the host computing system 204 may be based on a User-Datagram Protocol (UDP). It may be appreciated by those skilled in the art, the UDP may be a preferred protocol for its ability to provide a high-speed connection. It may be further appreciated that the UDP may carry data in discrete packets with very low overhead and in high transmission speed, thereby enabling a high-speed connection. It may be noted that the host computing system 204 may be network time protocol (NTP) enabled, to allow the system time of host computing system 204 to be synchronized with the Coordinated Universal Time (UTC) as retrieved from the network time. Further, owing to the synchronization with the UTC, the system time of host computing system 304 may be synchronized with the UTC within a few milliseconds.

Once the local area network is established, each device of the devices 202 must “listen” to the local area network 212 so as to catch any messages that the host computing system 204 may broadcast. Each device of the devices 202 may retrieve the network time via the host computing system 204. In an embodiment, each device of the devices 202 may retrieve the network time via the host computing system 204 based on a Simple Network Time Protocol (SNTP client). It may be appreciated that the SNTPClient or SNTPClient.java is provided by Google® through “Android Open Source Project”. It may be further noted that each device of the devices 302 may retrieve network time from the host computing system 204 based on URL (for example, 172.20.10.2 and time.foo.com) of the host computing system 204 and a desired request timeout duration (in milliseconds). Based on the SMTP client, each of the devices 202 may further determine at least one of an initial request time, a request transit time, and a request round-trip time.

It may be understood that there may exist an offset between the device time associated with each device of the devices 202 and the network time. For example, the device time may be advanced with respect to the network time as retrieved via the host computing system 204. Each device of the devices 202 may, therefore, determine the offset between the device time of each of the plurality of devices 202 and the network time. In other words, each of the devices 202 may determine the retrieved network time taking into account time consumed in requesting and retrieving the network time.

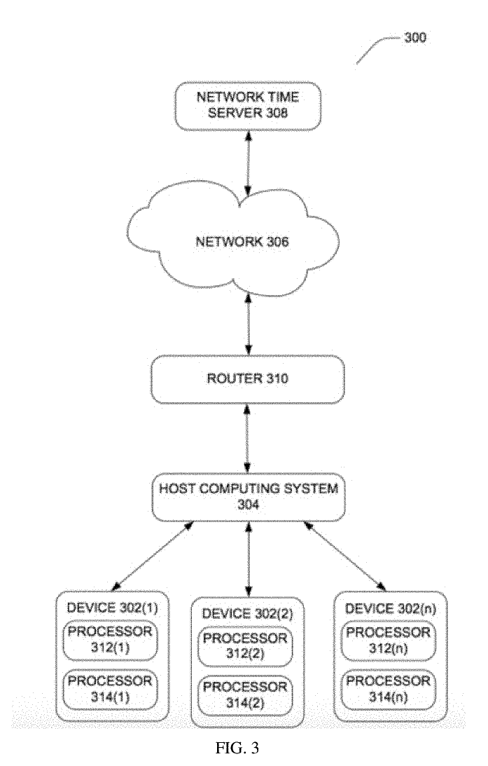

FIG. 3 shows an environment 300 for determining a time for executing a command on each of a plurality of devices, in accordance with another embodiment. The environment 300 may include a plurality of Android devices 302(1), 302(2) . . . 302(n), hereinafter, collectively referred to as devices 302 (corresponding to devices 102 of FIG. 1 and devices 202 of FIG. 2). It may be understood that each device of the devices 302 may be a computing device, such as a smartphone operating on the Android platform. The environment 300 may further include a router 310, a host computing system 304 and a network time server 308.

In an embodiment, each of the devices 302 may be communicatively coupled to the host computing system 304 through the router 310. Further, in an embodiment, each device of the devices 102 may be communicatively coupled to the host computing system 304 via a wireless network, such as Wi-Fi. As mentioned earlier, the host computing system 304 may be any computing device, such as a desktop, or a laptop, or a mobile phone operating on Microsoft Windows® platform. Further, in an embodiment, the host computer 304 may connect to the router 310 to establish a local area network thereby allowing each of the devices 302 to connect to the local area network and, hence, to the host computing system 304.

In an embodiment, each of the devices 302 may further include a countdown timer so as to schedule execution of a command at a future time. The countdown timer may allow for scheduling a command execution within a specific duration. In other words, the countdown timer may provide a window time to each of the devices 302 within which the command may be executed, regardless of the device time of each of the devices 302 is advanced or behind the network time.

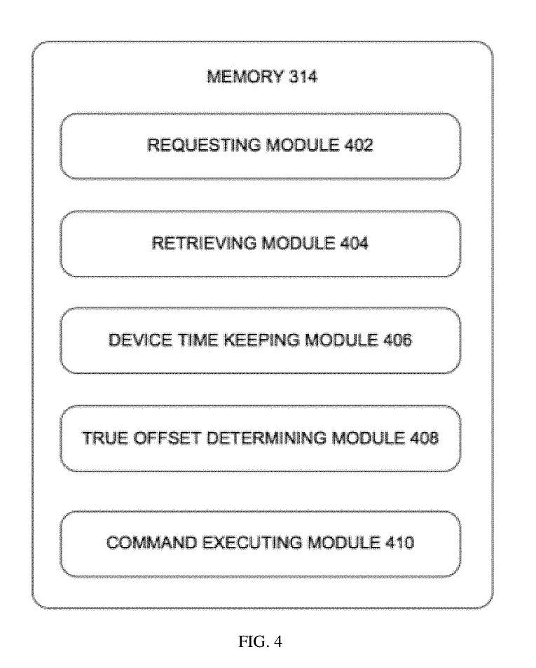

In order to perform the above-discussed functionalities, each of the devices 302 may include a processor 312(1), 312(4) . . . 312(n), collectively referred to as processor 312, and a memory 314(1), 314(4) . . . 314(n), collectively referred to as memory 314. The memory 314 may store instructions that, when executed by the processor 312, cause the processor 312 to perform various functionalities, as discussed in greater detail in FIG. 4 to FIG. 9. The memory 314 may be a non-volatile memory or a volatile memory. Examples of non-volatile memory may include, but are not limited to a flash memory, a Read Only Memory (ROM), a Programmable ROM (PROM), Erasable PROM (EPROM), and Electrically EPROM (EEPROM) memory. Examples of volatile memory may include but are not limited to Dynamic Random Access Memory (DRAM), and Static Random-Access memory (SRAM).

Referring now to FIG. 4, a functional block diagram of the memory 314 within each of the devices 302 configured to determine a time for executing a command on each device of the devices 302 is illustrated, in accordance with an embodiment. The memory 314 may include modules that may perform various functions. The memory 314 may include a requesting module 402, a retrieving module 404, a device timekeeping module 406, a true offset determining module 408 and a command executing module 410. As will be appreciated by those skilled in the art, all such aforementioned modules 402-410 may be represented as a single module or a combination of different modules. Moreover, as will be appreciated by those skilled in the art, each of the modules 402-410 may reside, in whole or in parts, on one device or multiple devices in communication with each other.

The requesting module 402 may be communicatively coupled to the host computing system 304 (not shown). The requesting module 402 may request the host computing system 304 for the network time. It may be noted that the host computing system 304 may be further communicatively coupled to a network time server 308. The host computing system 304 may communicate with the network time server 308 to receive the network time. It may be further noted that the network time server 308 may be a global time server that may retrieve the current time based on a Universal Time Coordinated (UTC) from a source, such as Global Positioning System (GPS). Accordingly, upon receiving the request from the device 400, the host computing system 304 may retrieve the network time from the network server 308.

The retrieving module 404 may retrieve the network time from the host computing system 304. Once the host computing system 304 has retrieved the network time from the network time server 308, the retrieving module 404 of the device 400 may retrieve the network time from the host computing system 304. The device timekeeping module 406 may determine the device time of the device 400. It may be understood that the device 400 may include a device clock to keep the device time. The device timekeeping module 406 may, therefore, coordinate with the device clock to determine the device time of the device 400.

The true offset determining module 408 may then determine a true offset between the network time and the device time associated with the device 400. In an embodiment, the true offset determining module 408 may determine the true offset iteratively, based on a predetermined offset threshold range (POTR).

In an embodiment, the true offset determining module 408 may determine an initial offset as a difference between the network time and the device time associated with the device 400. The true offset determining module 408 may further determine a time to base offset (TTBO) as a summation of the device time associated with the device 400 and the initial offset. Thereafter, the true offset determining module 408 may determine an offset threshold flag (OTF) as a difference between the retrieved network time and the TTBO. The true offset determining module 408 may further determine a probable offset by adjusting the initial offset with the OTF. Upon determining the probable offset, the true offset determining module 408 may compare the OTF and the POTR. Based on the comparison, if the OTF lies within POTR, the true offset determining module 408 may select the probable offset as the true offset.

However, if the OTF lies outside POTR, the true offset determining module 408 may attempt to determine the true offset by repeating the above process. By way of an example, if the OTF lies outside POTR, the true offset determining module 408 may select the previous probable offset as the initial offset. It may be noted that during each iteration, the true offset determining module 408 may determine the current network time and the device time of the device 302 for determining various parameters, such as TTBO, OTF, and a probable offset. Thereafter, the true offset determining module 408 may once again determine a TTBO as the summation of the device time of each of the plurality of devices and the initial offset (i.e. the previous probable offset). The true offset determining module 408 may then once again determine an OTF as the difference between the retrieved network time and the TTBO. The true offset determining module 408 may then determine another probable offset by adjusting the initial offset with the OTF. Then true offset determining module 408 may compare the OTF and the POTR. Based on the comparison, if the OTF lies within POTR, the true offset determining module 408 may then select the (new) probable offset as the true offset. However, if the OTF lies outside POTR, the true offset determining module 408 may once again attempt to determine the true offset by repeating the above process to determine a probable offset, until the OTF lies within the POTR. It may be noted that the true offset determining module 408 may use an algorithm that may be run iteratively one or more times for determining a true offset between the network time and the device time associated with each of the devices 302.

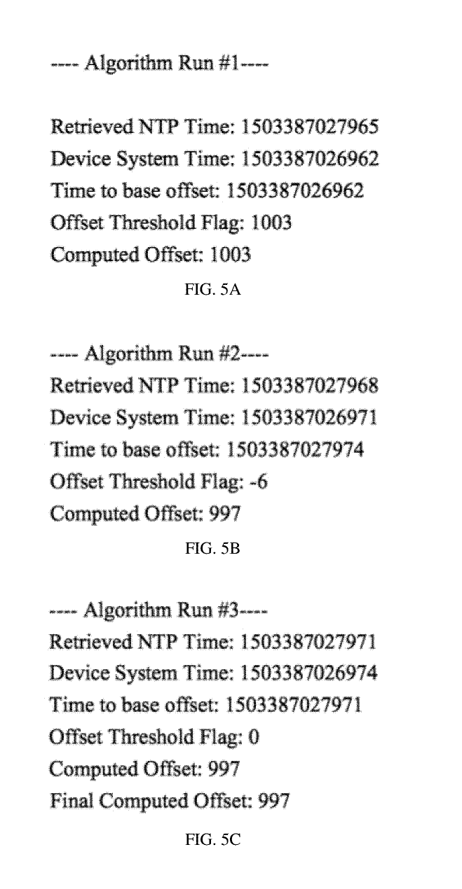

Referring now the FIG. 5A, a first run of the algorithm used by the true offset determining module 408 for determining a true offset between the network time and the device time associated with each device of the devices 302 is illustrated, in accordance with an embodiment. As shown in the FIG. 5A, according to the algorithm, the network time (NTP time) is retrieved and the device time of each of the plurality of devices is determined. In the given example, the retrieved network time (NTP time) is 1503387027965, and the determined device time is 1503387026962. A time to base offset (TTBO) is determined as the summation of the device time and a previous probable offset, i.e.

Time to base offset(TTBO)=(Device time+Previous Probable Offset) Equation (1)

In the first run of the algorithm, the previous probable offset is assumed to be zero, as there does not exist a previous probable offset. Accordingly, the TTBO for the first run of the algorithm is determined as:

TTBO=1503387026962+0=1503387026962

Thereafter, an Offset Threshold Flag (OTF) is determined as the difference of retrieved network time and TTBO, i.e.

Offset Threshold Flag(OTF)=(Retrieved network Time−TTBO) Equation(2)

Accordingly, the OTF may be determined as:

OTF=1503387027965−1503387026962=1003

Thereafter, according to the algorithm, a probable offset is determined by adjusting the previous offset with the OTF. Thus, the probable offset is determined to be 1003 (as the previous probable offset for the first run of the algorithm is assumed to be zero).

The OTF is then compared with a predetermined offset threshold range (POTR). It may be noted that the POTR may be defined initially by a user. For example, the POTR is defined as 0-5. Based on the comparison, the probable offset is selected as a true offset if the corresponding OTF lies within POTR, i.e. the OTF ≤5.

As mentioned earlier, the algorithm may be run multiple times so as to iteratively determine the time for executing a command on a device, until the determined OTF lies within POTR. FIG. 5B shows a second run of the algorithm used by the true offset determining module 408 for determining a true offset between the network time and the device time of each of the plurality of devices. As shown in the FIG. 5B, according to the algorithm, once again the network time (NTP time) is retrieved and the device time of each device of the devices 302 is determined. For example, the retrieved network time (NTP time) is 1503387027968, and the determined device time is 1503387026971. The TTBO is determined as:

Time to base offset(TTBO)=1503387026971+1003(Device time+Previous Probable Offset)=1503387027974(The previous probable offset is 1003, as determined in the first run of the algorithm).

Thereafter, the OTF is determined as:

OTF=1503387027968−1503387027974(Retrieved Network Time−TTBO)=−6

Thereafter, the probable offset is determined as:

Probable offset=1003+(−6)(Previous computed offset+OTF)=997

However, as the OTF lies outside the POTR, this probable offset (i.e. 997) cannot be selected as a true offset. Accordingly, a third run of the algorithm becomes necessary.

FIG. 5C shows a third run of the algorithm used by the true offset determining module 408 for determining a true offset between the network time and the device time of each device of the devices 302. As shown in the FIG. 5C, the retrieved network time (NTP time) is 1503387027971, and the device time is 1503387026974. The TTBO is determined as:

Time to base offset(TTBO)=1503387026974+997(Device time+Previous Probable Offset)=1503387027971(The previous probable offset is 997, as determined in the second run of the algorithm).

Thereafter, the OTF is determined as:

OTF=1503387027971−1503387027971(Retrieved Network Time−TTBO)=Probable offset is determined as:

Probable offset=997+0(Previous Probable offset+OTF)=997

As the OTF (i.e. 0) lies within the POTR (0<5), the second probable offset i.e. 997 is selected as true offset. Hence, the true offset is determined as 997.

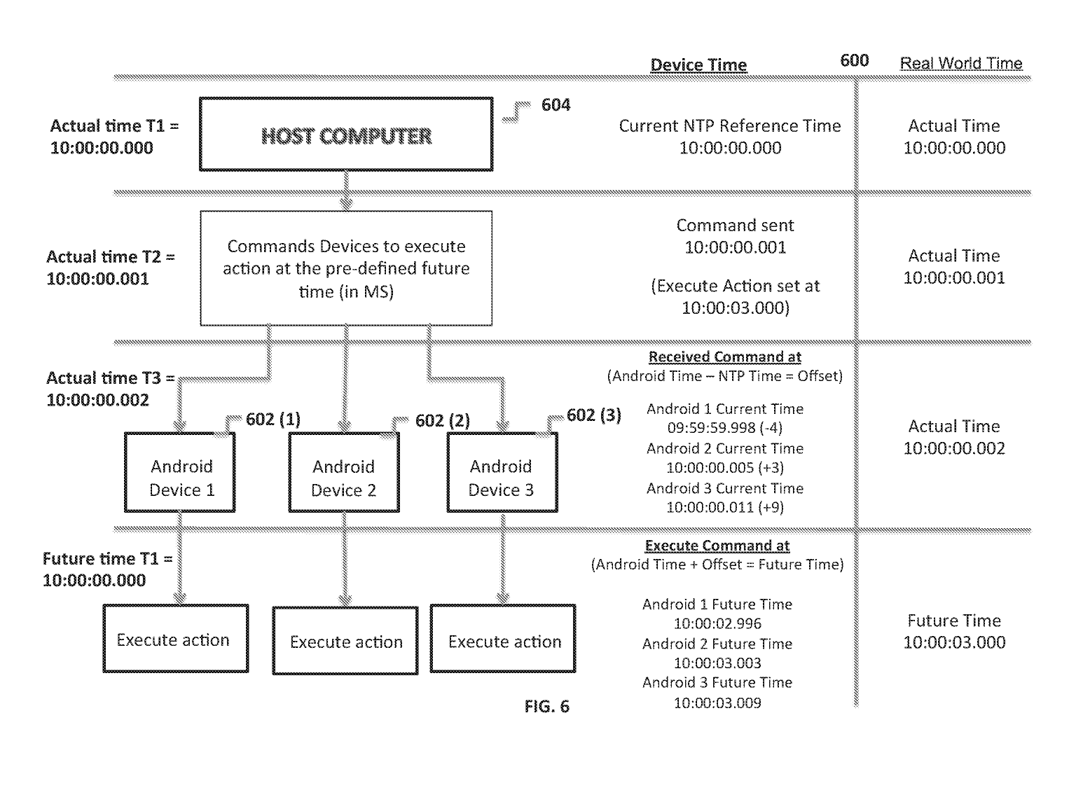

FIG. 6 illustrates an exemplary timing chart 600 of determining a time for executing a command on Android devices 602(1), 602(2) and 602(3), in accordance with an embodiment. The timing chart 600 is plotted with respect to actual time. It may be noted that the actual time may be the real world time as regulated by the Coordinated Universal Time (UTC).

At actual time T1=10:00.00.000, network time (also, referred to as current NTP reference time) as retrieved by a host computing system 604 is recorded as 10:00.00.000. At actual time T2=10:00.00.001, the host computing system 604 commands the Android devices 602(1), 602(2) and 602(3) to execute a command (action) at a pre-defined future time. In the given example, the host computing system 604 commands the Android devices 602(1), 602(2) and 602(3) to execute the command at actual future time 10:00.03.000.

At actual time T3=10:00.00.002, the Android devices 602(1), 602(2) and 602(3) receive the command from the host computing system 604. It may be noted that at this point of the time, there may exist an offset between the device time of each of the Android devices 602(1), 602(2) and 602(3) and the actual time (or the network time). The offset (true offset) may be determined by the Android devices as per the methodology provided above in the present disclosure. As such, the device time of each of the Android devices may be deviated from the network time (NTP time) by an amount equal to the offset. The device time may be represented as:

Device time=Network time(NTP time)+Offset Equation 3

Accordingly, at actual time T3=10:00.0.002, the device time associated with the Android device 602(1) is recorded to be 09:59.59.998, (having an offset of −4), the device time associated with the Android device 602(2) is recorded to be 10:00.0.005, (having an offset of +3), and the device time associated with the Android device 602(3) is recorded to be 10:00.0.011, (having an offset of +9).

At actual time T4=10:00.00.003, the host computing system 604 may execute the command on the Android devices 602(1), 602(2) and 602(3). Based on the offset, the host computing system may determine a future device time associated with the Android devices 602(1), 602(2) and 602(3) at which the command could be executed. The host computer determines a future device time associated with the Android devices 602(1), 602(2) and 602(3) as:

Device time=Offset+Future time scheduled for executing the command Equation 3

The host computer determines a future device times associated with the Android devices 602(1), 602(2) and 602(3) for executing the command as:

device time for Android devices 602(1)=−4+10:00.00.003=10:00.02.996;

device time for Android devices 602(2)=+3+10:00.00.003=10:00.03.003;

and

device time for Android devices 602(3)=+9+10:00.00.003=10:00.03.009.

Thus, the host computing system 604 may execute the command on Android devices 602(1), 602(2) and 602(3) at device times 10:00.02.996, 10:00.03.003, and 10:00.03.009, respectively.

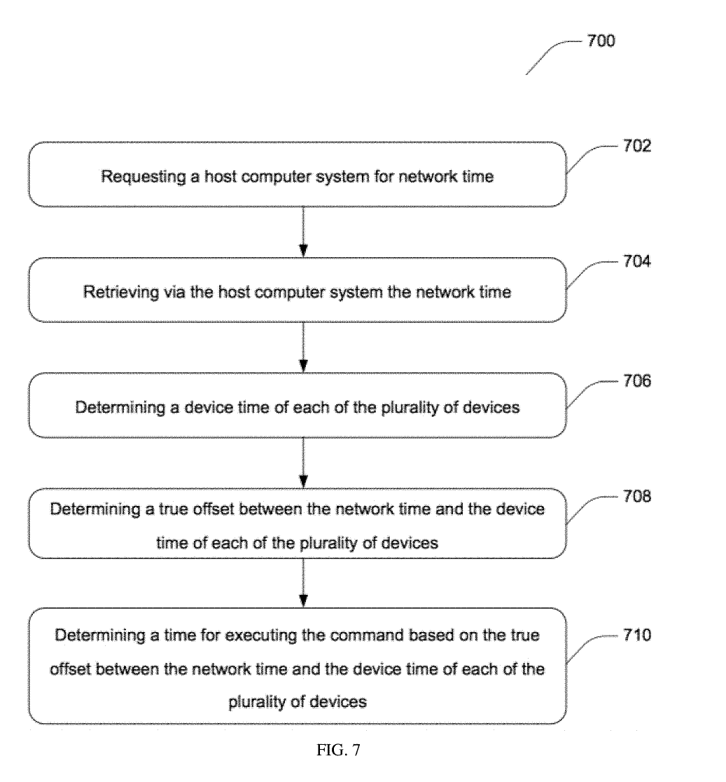

Referring now to FIG. 7, a flowchart 700 of a method for determining a time for executing a command on a device of a plurality of devices 302 is illustrated, in accordance with an embodiment. In an embodiment, the method may be performed by a processor 312 of each of the devices 302.

At step 702, a host computing system 304 may be requested for network time. As mentioned earlier, the host computing system 304 may communicate with the network time server 308 to receive the network time. Further, the network time server 308 may be a global time server that may retrieve the current time based on a Universal Time Coordinated (UTC) from a source, such as Global Positioning System (GPS). Accordingly, upon receiving the request, the host computing system 304 may retrieve the network time from the network server 308.

At step 704, the network time may be retrieved via the host computing system. The network time may be retrieved once the host computing system 304 has retrieved the network time from the network time server 308. At step 706, a device time associated with each of the devices 302 may be determined. It may be understood that each device of the devices 302 may include a device clock to keep the device time. Therefore, the device time associated with each of the devices 302 may be retrieved by coordinating with the device clock.

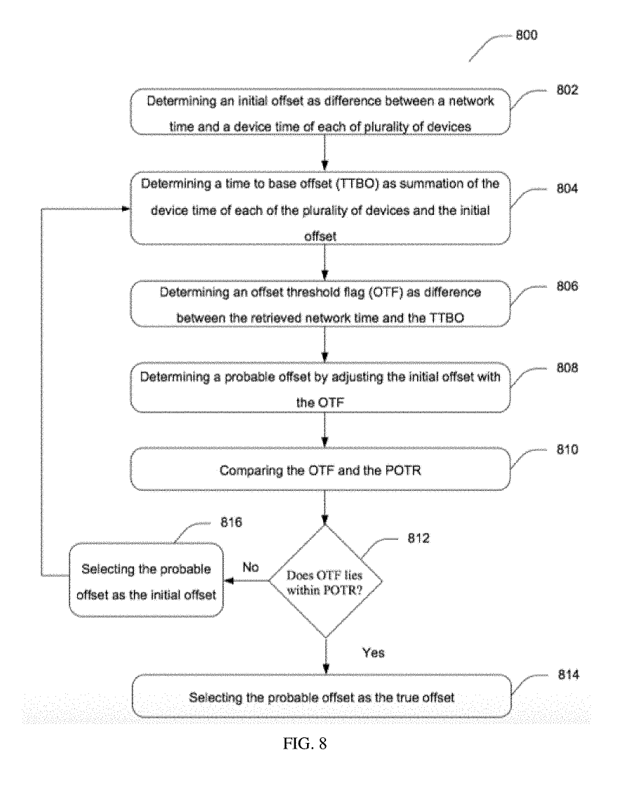

At step 708, a true offset between the network time and the device time associated with each device of the devices 302 may be determined. In an embodiment, the true offset between the network time and the device time may be determined iteratively based on a predetermined offset threshold range (POTR). It may be noted that the POTR may be defined by a user. The method of determining the true offset between the network time and the device time is further explained in detail in conjunction with FIG. 8.

At step 710, a time for executing the command may be determined based on the true offset between the network time and the device time of each device of the devices 302. By way of an example, based on the true offset determined, a waiting time or delay may be applied to the device time associated with each device of the devices 302, so as to determine the time for executing the command on each of the devices 302. In other words, by applying a waiting time or delay to the device time associated with each of the devices 302, a future time may be scheduled for executing the command on each device of the devices 302.

Referring now to FIG. 8, a flowchart 800 of a method for determining a true offset between the network time and the device time associated with each device of the devices illustrated, in accordance with an embodiment. At step 802, an initial offset may be determined. The initial offset may be determined as a difference between the network time and the device time of each device of devices 302. At step 804, a time to base offset (TTBO) may be determined. The time to base offset (TTBO) may be determined as the summation of the device time associated with each device of the devices 302 and the initial offset. At step 806, an offset threshold flag (OTF) may be determined. The offset threshold flag (OTF) may be determined as the difference between the retrieved network time and the TTBO. At step 808, a probable offset may be determined by adjusting the initial offset with the OTF. At step 810, the OTF and the POTR are compared. At step 812, a decision is taken based on the comparison of OTF and the POTR. If the OTF lies with the POTR, the method proceeds to the step 814 (‘Yes’ path). At step 814, the probable offset may be selected as the true offset.

Returning back to the step 812, if the OTF lies outside the POTR, the method proceeds back to step 804 (‘No’ path). Accordingly, the steps 804-812 are repeated, until the OTF is found to lie within the POTR.

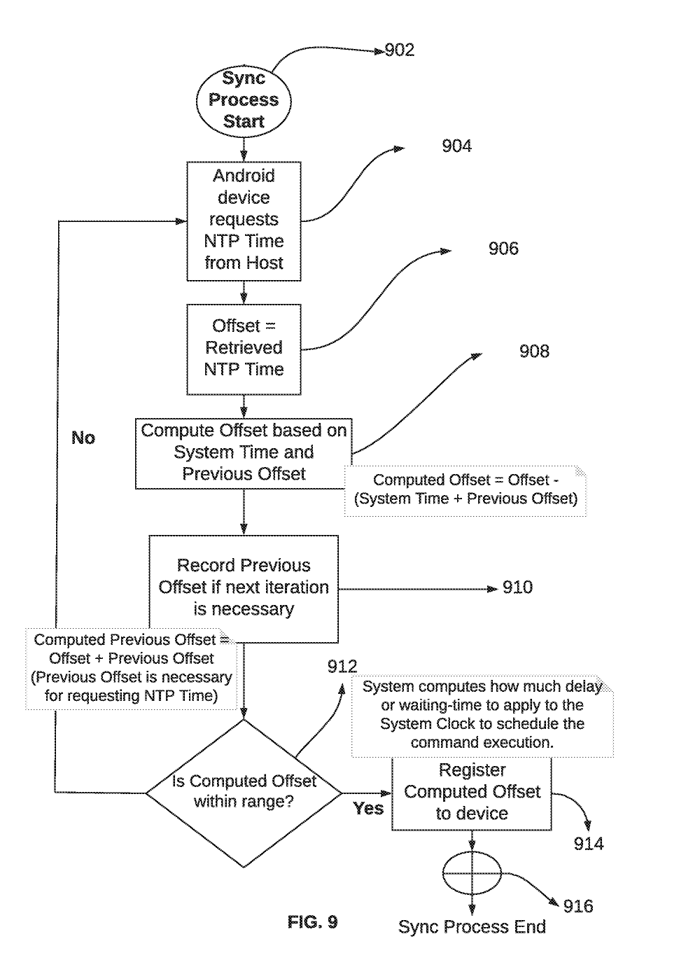

Referring now to FIG. 9, a flowchart 900 of a method for synchronizing a device time associated with an Android device of a plurality of Android devices with network time is illustrated, in accordance with an embodiment. At step 902, the method for synchronizing the device time associated with each of the Android devices is started. At step 904, a host computing system may be requested for the network time (also referred to as NTP time). At step 906, the network time may be retrieved via the host computing system 304. Further, at step the 906, device time (also referred to as, System time) associated with the Android device may be determined. It may be understood that an offset may exist between the device time associated with each Android device and the network time. At step 908, a probable offset (also referred to as, computed offset) may be determined based on the device time associated with the Android device and a previous probable offset. The probable offset may be determined as:

Probable offset(Computed offset)=Offset−(retrieved network time+previous probable offset)

At step 910, the previous probable offset is recorded, and it is determined if a further iteration for determining a true offset is required. It may be noted that for determining whether a further iteration for determining a true offset is required or not, a time to base offset (TTBO) may be determined as the summation of the device time of each of the plurality of Android devices and the initial offset. Further, an offset threshold flag (OTF) may be determined as the difference between the retrieved network time and the TTBO. Further, the probable offset may be determined by adjusting the initial offset with the OTF. For example, the probable offset may be determined as:

Probable offset(Computed offset)=OTF+Previous Probable offset

Further, the OTF and the POTR may be compared, and based on the comparison, if the OTF lies with the POTR, the probable offset is recorded as the true offset. However, if the OTF lies outside the POTR, a next iteration is necessary.

At step 912, once again a probable offset and an OTF is determined based on step 910, and the OTF is compared with the POTR to determine if the OTF lies within the POTR. If the OTF lies within the POTR, the method 900 proceeds to step 914. At step 914, the probable offset determined at step 912 is registered as a true offset. Further, based on the true offset, a delay or waiting time to be applied to the device time associated with each of the Android devices is determined so as to schedule a command for execution. Returning back to step 912, if the OTF lies outside the POTR, the method 900 proceeds back to step 904. The steps 904-912 of the method 900 are repeated until the determined OTR is found to lie within the POTR. At step 916, the method 900 is stopped.

As will be also appreciated, the above-described techniques may take the form of computer or controller implemented processes and apparatuses for practicing those processes. The disclosure can also be embodied in the form of computer program code containing instructions embodied in tangible media, such as floppy diskettes, solid state drives, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

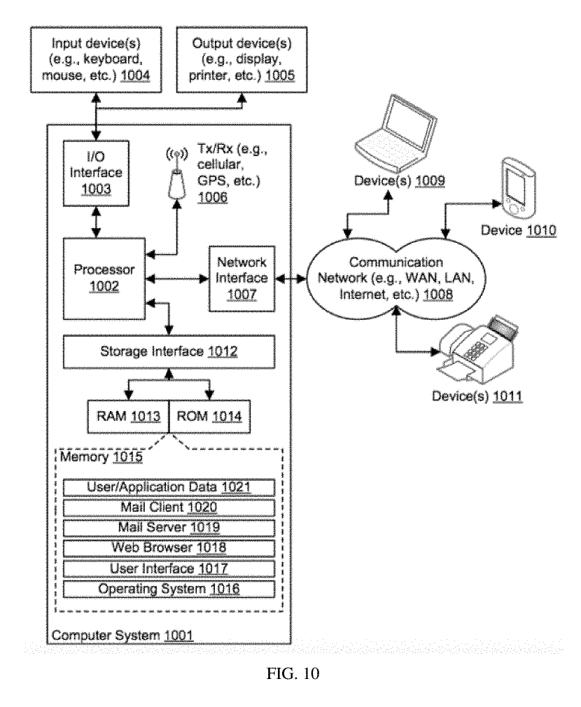

The disclosed methods and systems may be implemented on a conventional or a general-purpose computer system, such as a personal computer (PC) or server computer. Referring now to FIG. 10, a block diagram of an exemplary computer system 1002 for implementing various embodiments is illustrated. Computer system 1002 may include a central processing unit (“CPU” or “processor”) 1004. Processor 1004 may include at least one data processor for executing program components for executing user or system-generated requests. A user may include a person, a person using a device such as such as those included in this disclosure, or such a device itself. Processor 1004 may include specialized processing units such as integrated system (bus) controllers, memory management control units, floating point units, graphics processing units, digital signal processing units, etc. Processor 1004 may include a microprocessor, such as AMD® ATHLON® microprocessor, DURON® microprocessor OR OPTERON® microprocessor, ARM's application, embedded or secure processors, IBM® POWERPC®, INTEL'S CORE® processor, ITANIUM® processor, XEON® processor, CELERON® processor or other line of processors, etc. Processor 1004 may be implemented using the mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 1004 may be disposed of in communication with one or more input/output (I/O) devices via an I/O interface 1006. I/O interface 1006 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (for example, code-division multiple access (CDMA), high-speed packet access (HSPA+), global system for mobile communications (GSM), long-term evolution (LTE), WiMax, or the like), etc.

Using I/O interface 1006, computer system 1002 may communicate with one or more I/O devices. For example, an input device 1008 may be an antenna, keyboard, mouse, joystick, (infrared) remote control, camera, card reader, fax machine, dongle, biometric reader, microphone, touch screen, touchpad, trackball, sensor (for example, accelerometer, light sensor, GPS, gyroscope, proximity sensor, or the like), stylus, scanner, storage device, transceiver, video device/source, visors, etc. An output device 1010 may be a printer, fax machine, video display (for example, cathode ray tube (CRT), liquid crystal display (LCD), light-emitting diode (LED), plasma, or the like), audio speaker, etc. In some embodiments, a transceiver 1012 may be disposed of in connection with processor 1004. Transceiver 1012 may facilitate various types of wireless transmission or reception. For example, transceiver 1012 may include an antenna operatively connected to a transceiver chip (for example, TEXAS® INSTRUMENTS WILINK WL1286® transceiver, BROADCOM® BCM4550IUB8® transceiver, INFINEON TECHNOLOGIES® X-GOLD 618-PMB9800® transceiver, or the like), providing IEEE 802.6a/b/g/n, Bluetooth, FM, global positioning system (GPS), 2G/3G HSDPA/HSUPA communications, etc.

In some embodiments, processor 1004 may be disposed of in communication with a communication network 1014 via a network interface 1016. Network interface 1016 may communicate with communication network 1014. Network interface 1016 may employ connection protocols including, without limitation, direct connect, Ethernet (for example, twisted pair 50/500/5000 Base T), transmission control protocol/internet protocol (TCP/IP), token ring, IEEE 802.11a/b/g/n/x, etc. The communication network 1014 may include, without limitation, a direct interconnection, local area network (LAN), wide area network (WAN), a wireless network (for example, using Wireless Application Protocol), the Internet, etc. Using network interface 1016 and communication network 1014, computer system 1002 may communicate with devices 1018, 1020, and 1022. These devices may include, without limitation, personal computer(s), server(s), fax machines, printers, scanners, various mobile devices such as cellular telephones, smartphones (for example, APPLE® IPHONE® smartphone, BLACKBERRY® smartphone, ANDROID® based phones, etc.), tablet computers, eBook readers (AMAZON® KINDLE® e-reader, NOOK® tablet computer, etc.), laptop computers, notebooks, gaming consoles (MICROSOFT® XBOX® gaming console, Nintendo® DS® gaming console, Sony® PLAYSTATION® gaming console, etc.), or the like. In some embodiments, computer system 1002 may itself embody one or more of these devices.

In some embodiments, processor 1004 may be disposed of in communication with one or more memory devices (for example, RAM 1026, ROM 1028, etc.) via a storage interface 1024. Storage interface 1024 may connect to memory 1030 including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

Memory 1030 may store a collection of program or database components, including, without limitation, an operating system 1032, user interface application 1034, web browser 1036, mail server 1038, mail client 1040, user/application data 1042 (for example, any data variables or data records discussed in this disclosure), etc. Operating system 1032 may facilitate resource management and operation of computer system 1002. Examples of operating systems 1032 include, without limitation, APPLE® MACINTOSH® OS X platform, UNIX platform, Unix-like system distributions (for example, Berkeley Software Distribution (BSD), FreeBSD, NetBSD, OpenBSD, etc.), Linux distributions (for example, RED HAT®, UBUNTU®, KUBUNTU®, etc.), IBM® OS/2 platform, MICROSOFT® WINDOWS® platform (XP, Vista/7/8, etc.), APPLE® IOS® platform, GOOGLE® ANDROID® platform, BLACKBERRY® OS platform, or the like. User interface 1034 may facilitate display, execution, interaction, manipulation, or operation of program components through textual or graphical facilities. For example, user interfaces may provide computer interaction interface elements on a display system operatively connected to computer system 1002, such as cursors, icons, checkboxes, menus, scrollers, windows, widgets, etc. Graphical user interfaces (GUIs) may be employed, including, without limitation, Apple® Macintosh® operating systems' AQUA® platform, IBM® OS/2® platform, MICROSOFT® WINDOWS® platform (for example, AERO® platform, METRO® platform, etc.), UNIX X-WINDOWS, web interface libraries (for example, ACTIVEX® platform, JAVA® programming language, JAVASCRIPT® programming language, AJAX® programming language, HTML, Adobe® FLASH® platform, etc.), or the like.

In some embodiments, computer system 1002 may implement a web browser 1036 stored program component. Web browser 1036 may be a hypertext viewing application, such as MICROSOFT® INTERNET EXPLORER® web browser, GOOGLE® CHROME® web browser, Mozilla® FIREFOX® web browser, APPLE® SAFARI® web browser, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe® FLASH® platform, JAVASCRIPT® programming language, JAVA® programming language, application programming interfaces (APIs), etc. In some embodiments, computer system 1002 may implement a mail server 1038 stored program component. Mail server 1038 may be an Internet mail server such as MICROSOFT® EXCHANGE® mail server, or the like. Mail server 1038 may utilize facilities such as ASP, ActiveX, ANSI C++/C#, MICROSOFT .NET® programming language, CGI scripts, JAVA® programming language, JAVASCRIPT® programming language, PERL® programming language, PHP® programming language, Python® programming language, WebObjects, etc. Mail server 1038 may utilize communication protocols such as internet message access protocol (IMAP), messaging application programming interface (MAPI), Microsoft Exchange, post office protocol (POP), simple mail transfer protocol (SMTP), or the like. In some embodiments, computer system 1002 may implement a mail client 1040 stored program component. Mail client 1040 may be a mail viewing application, such as APPLE MAIL® mail client, MICROSOFT ENTOURAGE® mail client, MICROSOFT OUTLOOK® mail client, Mozilla THUNDERBIRD® mail client, etc.

In some embodiments, computer system 1002 may store user/application data 1042, such as the data, variables, records, etc. as described in this disclosure. Such databases may be implemented as fault-tolerant, relational, scalable, secure databases such as Oracle® database OR SYBASE® database. Alternatively, such databases may be implemented using standardized data structures, such as an array, hash, linked list, struct, structured text file (for example, XML), table, or as object-oriented databases (for example, using OBJECTSTORE® object database, POET® object database, ZOPE® object database, etc.). Such databases may be consolidated or distributed, sometimes among the various computer systems discussed above in this disclosure. It is to be understood that the structure and operation of any computer or database component may be combined, consolidated, or distributed in any working combination.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

As will be appreciated by those skilled in the art, the techniques described in the various embodiments discussed above pertain to determining a time for executing a command on a device of a plurality of devices. The techniques may employ an algorithm that may run repeatedly so as to iteratively determine the time for executing a command on the device. The techniques allow for compensating the offset that exists between the device time associated with a device and the network time without needing to change the device time. Further, the techniques of the present discloser provide an accurate way of compensating the offset between device time associated with the device and network time as retrieved via a host computer device.

The specification has described method and system for determining a time for executing a command on a device of a plurality of devices. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternate boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

1. A method of determining a time for executing a command on a device of a plurality of devices, the method comprising:
requesting, by a processor, a host computing system for network time;
retrieving, by the processor, via the host computing system the network time;
determining, by the processor, a device time of each of the plurality of devices;
determining, by the processor, a true offset between the network time and the device time of each of the plurality of devices, wherein the true offset between the network time and the device time of each of the plurality of devices is determined iteratively based on a predetermined offset threshold range (POTR); and
determining, by the processor, the time for executing the command based on the true offset between the network time and the device time of each of the plurality of devices.

2. The method of claim 1, wherein determining the true offset between the network time and the device time of each of the plurality of devices further comprises:
(a) determining an initial offset as a difference between the network time and the device time of each of the plurality of devices;
(b) determining a time to base offset (TTBO) as a summation of the device time of each of the plurality of devices and the initial offset;
(c) determining an offset threshold flag (OTF) as a difference between the retrieved network time and the TTBO;
(d) determining a probable offset by adjusting the initial offset with the OTF;
(e) comparing the OTF and the POTR; and
(f) based on the comparison, selecting the probable offset as the true offset when the OTF lies within POTR.

3. The method of claim 2, wherein when the OTF lies outside POTR, the method further comprises:
selecting the probable offset as the initial offset; and
repeating the steps (b) to (f).

4. The method of claim 1, wherein each of the plurality of devices is connected to the host computing system via a wireless connection.

5. The method of claim 4, wherein the connection between each of the plurality of devices and the host computing system is based on a User-Datagram Protocol (UDP).

6. The method of claim 1, wherein the network time is retrieved via the host computing system using Simple Network Time Protocol (SNTP client).

7. The method of claim 6, wherein the method further comprises determining at least one of an initial request time, a request transit time, and a request round-trip time.

8. The method of claim 1, wherein each of the plurality of devices operates on Android platform, and wherein the host computing system operates on Microsoft Windows platform.

9. A computing device for determining a time for executing a command on each of a plurality of devices, the system comprising:
a processor; and
a memory communicatively coupled to the processor, wherein the memory stores processor instructions, which, on execution, causes the processor to:
request a host computing system for network time;
retrieve via the host computing system the network time;
determine a device time of each of the plurality of devices;
determine a true offset between the network time and the device time of each of the plurality of devices, wherein the true offset between the network time and the device time of each of the plurality of devices is determined iteratively based on a predetermined offset threshold range (POTR); and
determine the time for executing the command based on the true offset between the network time and the device time of each of the plurality of devices.

10. The system of claim 9, wherein determining the true offset between the network time and the device time of each of the plurality of devices comprises:
(a) determining an initial offset as a difference between the network time and the device time of each of the plurality of devices;
(b) determining a time to base offset (TTBO) as a summation of the device time of each of the plurality of devices and the initial offset;
(c) determining an offset threshold flag (OTF) as a difference between the retrieved network time and the TTBO;
(d) determining a probable offset by adjusting the initial offset with the OTF;
(e) comparing the OTF and the POTR; and
(f) based on the comparison, selecting the probable offset as the true offset when the OTF lies within POTR.

11. The system of claim 10, wherein when the OTF lies outside POTR, the processor is further to:
select the probable offset as the initial offset; and
repeat the steps (b) to (f).

12. The system of claim 9, wherein each of the plurality of devices is connected to the host computing system via a wireless connection, and wherein the connection between each of the plurality of devices and the host computing system is based on a User-Datagram Protocol (UDP).

13. The system of claim 9, wherein the processor retrieves the network time via the host computing system using Simple Network Time Protocol (SNTP client), and wherein based on the SNTP client class, the processor is further to determine at least one of an initial request time, a request transit time, and a request round-trip time.

14. The system of claim 9, wherein each of the plurality of devices operates on Android platform, and wherein the host computing system operates on Microsoft Windows platform.

15. A non-transitory computer-readable storage medium having stored thereon, a set of computer-executable instructions causing a computer comprising one or more processors to perform steps comprising:
requesting a host computing system for network time;
retrieving via the host computing system the network time;
determining a device time of each of the plurality of devices;
determining a true offset between the network time and the device time of each of the plurality of devices, wherein the true offset between the network time and the device time of each of the plurality of devices is determined iteratively based on a predetermined offset threshold range (POTR); and
determining the time for executing the command based on the true offset between the network time and the device time of each of the plurality of devices.

16. The non-transitory computer-readable storage medium of claim 15, wherein determining the true offset between the network time and the device time of each of the plurality of devices comprises:
(a) determining an initial offset as a difference between the network time and the device time of each of the plurality of devices;
(b) determining a time to base offset (TTBO) as a summation of the device time of each of the plurality of devices and the initial offset;
(c) determining an offset threshold flag (OTF) as a difference between the retrieved network time and the TTBO;
(d) determining a probable offset by adjusting the initial offset with the OTF;
(e) comparing the OTF and the POTR; and
(f) based on the comparison, selecting the probable offset as the true offset when the OTF lies within POTR.

17. The non-transitory computer-readable storage medium of claim 16, wherein when the OTF lies outside POTR, the computer-executable instructions are further to:
select the probable offset as the initial offset; and
repeat the steps (b) to (f).

18. The non-transitory computer-readable storage medium of claim 16, wherein each of the plurality of devices is connected to the host computing system via a wireless connection, and wherein the connection between each of the plurality of devices and the host computing system is based on a User-Datagram Protocol (UDP).

19. The non-transitory computer-readable storage medium of claim 16, wherein the computer-executable instructions are further to retrieve the network time via the host computing system using Simple Network Time Protocol (SNTP client), and wherein based on the SNTP Client class, the computer-executable instructions are further to determine at least one of an initial request time, a request transit time, and a request round-trip time.

20. The non-transitory computer-readable storage medium of claim 16, wherein each of the plurality of devices operates on Android platform, and wherein the host computing system operates on Microsoft Windows platform.
